(19) United States
(12) Patent Application Publication
(10) Pub. No.: US 2006/0033316 A1
(43) Pub. Date: Feb. 16, 2006

(54) Gas bag module having discharge vent

(75) Inventor: Markus Keutz, Rossdorf (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive Safety Systems GmbH

(21) Appl. No.: 11/198,128

(22) Filed: Aug. 5, 2005

(30) Foreign Application Priority Data
Aug. 13, 2004 (DE) 20 2004 012 721.0

(51) Int. Cl. B60R 21/30

(52) U.S. Cl. 280/739

(57) ABSTRACT

A gas bag module for a vehicle occupant restraint device has a gas generator (12) for filling a gas bag, a discharge vent (14) through which gas can escape, and a flap device (16). The discharge vent is formed in a rigid component (10) of the gas bag module. The flap device in a closed position covering the discharge vent (14) and in an open position unblocking the discharge vent (14). The gas bag module further comprises a locking mechanism which holds the flap device (16) in the open position.

### TECHNICAL FIELD

The present invention relates to a gas bag module for a vehicle occupant restraint device.

### BACKGROUND OF THE INVENTION

Discharge vents in the gas bag module can serve the purpose of preventing an excessive interior pressure from building up in the gas bag under certain conditions. Gas bag modules are known in which a flap integrated in the gas generator support or in a housing wall of the module closes a discharge vent and, when necessary, opens it, the flap swiveling on a flexible hinge from a closed to an open position. To ensure that the flap, after unblocking the discharge vent, remains reliably in the open position even under specific circumstances such as in the accelerations that occur in response to a secondary impact of the vehicle, the bending resistance of the hinge must be set a high level. However, this has the result that large adjusting forces and therefore cumbersome and large actuators are necessary in order to open the flap, and the process of opening the flap is negatively influenced especially with regard to time.

From U.S. 2004/0051286 A1, a gas bag module having a gas generator for filling a gas bag, a discharge vent through which gas can escape, and a flap device, is known. The discharge vent is formed in a rigid component of the gas bag module. A flap covering the discharge vent can be held in a closed position by means of a special retaining mechanism. A mechanism that operates in a similar manner is also shown in WO 98/31570 A1.

It is an object of the present invention to provide a gas bag module having a discharge vent that can be unblocked easily and reliably.

### BRIEF SUMMARY OF THE INVENTION

The gas bag module according to the invention has a gas generator for filling a gas bag, a discharge vent trough which gas can escape, and a flap device. The discharge vent is formed in a rigid component of the gas bag module. The flap device in a closed position covers the discharge vent and in an open position unblocks the discharge vent. The gas bag module further comprises a locking mechanism which holds the flap device in the open position. The present invention proceeds from the knowledge that a special locking mechanism, which can be realized using simple means, permits a far simpler construction of the flap device. It is no longer necessary to have a hinge possessing high bending resistance, because the locking mechanism assures that the flap device will reliably remain in the open position.

A design of the locking mechanism in which the mechanism is automatically activated when the flap device moves from the closed to the open position has proved to be especially advantageous. Otherwise, additional measures for actually achieving the locking effect would be necessary. Moreover, such additional measures would be necessary. Moreover, such additional measures would have to be activated synchronously with respect to the opening the flap device.

For example, the locking mechanism can have at least one latching element which is formed on the flap device.

The present invention provides that the flap device can be made out of plastic. In contrast to hitherto common stamped metal parts, a plastic flap device, in addition to the reduced weight, also has the advantage of complete moldability, because in accordance with plastic injection molding techniques, virtually any desired shape can be produced, in particular, special three-dimensional shapes.

Advantageously, the flap device can be moved via a film hinge from the closed to the open position. A film hinge is easy to manufacture and requires only minimal bending forces for swiveling the flap, so that a simple actuator can be used for activating the flap device.

### BRIEF DESCRIPTION OF THE DRAWINGS

FIG. 1 depicts a perspective view of one part of a gas bag module according to the present invention;

FIG. 2 depicts a schematic front view of the flap device of the gas bag module; and

FIG. 3 depicts a side sectional view of the flap device.

### DETAILED DESCRIPTION OF THE PREFERRED EMBODIMENTS

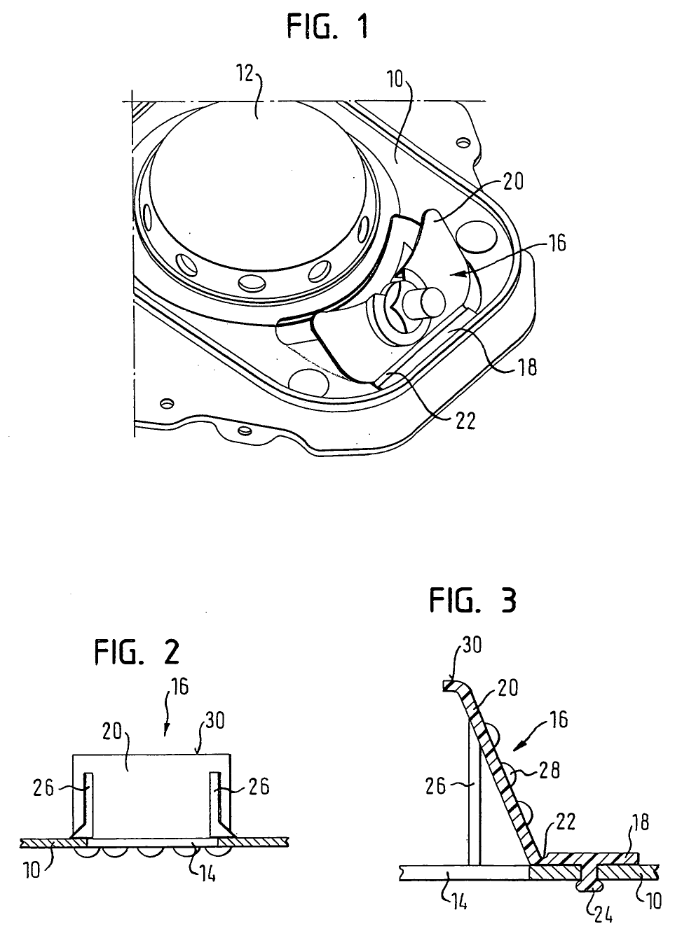

In FIG. 1, a gas generator 12 for filling a gas bag is depicted. The gas generator 12 is mounted on a metal gas generator support 10. The gas generator 12 and the gas bag are part of a gas bag module. In the gas generator support 10, a discharge vent 14 is provided (see FIGS. 2 and 3). Using a flap device 16, the discharge vent 14 can be covered or, as shown in the Figures, unblocked. For regulating the pressure in the gas bag, gas can be diverted by unblocking the discharge vent 14. The discharge vent 14 can also be formed in another rigid component of the gas bag module, for example, in a housing wall. The activating mechanism (actuator) and the control unit for opening and closing the flap device 16 do not pertain to the subject matter of the present invention, so no detailed explanation is provided here in this regard.

The flap device 16 is made entirely of plastic and can be manufactured in a proven injection molding process. The flap device 16 has an attachment section 18 and a flap section 20, between which a film hinge 22 is configured. The attachment section 18 is attached to the gas generator support 10 by ultrasound welding or hot caulking (see reference numeral 24 in FIG. 3), the gas generator support 10 being executed as a stamped metal part. In this way, the flap device 20 can be swiveled from a closed position, in which the discharge vent 14 is covered, to an open position, in which the discharge vent 14 is unblocked. The flap device 16 does not necessarily have to be attached to gas generator support 10. For example, it is also conceivable to attach the flap device 16 to a housing wall or a covering cap of the gas bag module.

A locking mechanism in the form of two latching hooks 26 that are injection molded onto the flap device 16 automatically assures that the flap device 16, after opening, will remain in the open position. In the open position, the latching hooks 26 are supported at the edge of the discharge vent 14 and thus prevent the flap section 20 from closing. The locking mechanism can also be realized in a different way, for example, via latching hooks that are injection molded on the gas generator support 10.

To improve the stability of the flap section 20, the latter is provided with ribs 28, which do not have to be formed subsequently if the injection molding die for the flap device 16 is appropriately designed. For an optimal seal of the discharge vent 14 in the closed position of the flap device 16, a sealing lip 30, which has a lower Shore hardness than the flap section 20, is provided on the edge of flap section 20. The sealing lip 30 can be formed on flap section 20, for example, in a two-component injection molding process.

In the case of a plastic gas generator support, the flap device 16 having the locking mechanism can be formed together with the gas generator support in a one or more component injection molding process in a single injection molding die.

1. A gas bag module for a vehicle occupant restraint device, the gas bad module having a gas generator for filling a gas bag, a discharge vent through which gas can escape, and a flap device, the discharge vent being formed in a rigid component of the gas bag module, the flap device in a closed position covering the discharge vent and in an open position unblocking the discharge vent, the gas bag module further comprising a locking mechanism which holds the flap device in the open position.

2. The gas bag module as recited in claim 1, wherein the locking mechanism is designed such that the locking mechanism is automatically activated when the flap device moves from the closed position to the open position.

3. The gas bag module as recited in claim 1, wherein the locking mechanism has at least one latching element which is formed on the flap device.

4. The gas bag module as recited in claim 1, wherein the locking mechanism has at least one latching element which is formed on the rigid component having the discharge vent.

5. The gas bag module as recited in claim 1, wherein the flap device is made of plastic.

6. The gas bag module as recited in claim 5, wherein the flap device includes a film hinge to enable movement of the flap device from the closed to the open position.

7. The gas bag module as recited in claim 5, wherein the flap device has a sealing lip.

8. The gas bag module as recited in claim 5, wherein the flap device has reinforcing ribs.

9. The gas bag module as recited in claim 5, wherein the rigid component having the discharge vent is made of metal, the flap device being attached to the rigid component by one of an ultrasound welding and a hot caulking process.

10. The gas bag module as recited in claims 1, wherein the gas bag module further comprises a gas generator support made of plastic, the flap device being configured as an integral part of the gas generator support.
